(19) United States
(12) Patent Application Publication
(10) Pub. No.: US 2009/0059612 A1
(43) Pub. Date: Mar. 5, 2009

(54) Head lamp assembly for vehicles

(76) Inventors: Yueh-Hsun Yang, Tainan (TW); Hui-Chuan Huang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,135

(22) Filed: Aug. 30, 2007

(51) Int. Cl. B60Q 1/076

(52) U.S. Cl. 362/513

(57) ABSTRACT

A head lamp assembly includes a reflection member with a lamp located at a focus of the reflection member and a fixed board is fixed to the reflection member. A recess is defined in a top edge of the fixed board a high beam reflected from the reflection member passes through the recess. An electromagnetic valve is connected to a connection portion perpendicularly extending from the fixed board and located beside the reflection member. A barrier plate is pivotably connected to the fixed board by a pivot and normally blocks the recess of the fixed board. The barrier plate is pivoted away from the recess when the electromagnetic valve is operated. The electromagnetic valve is affected by the high temperature by the fixed board.

### FIELD OF THE INVENTION

The present invention relates to a head lamp assembly for vehicles and the electromagnetic valve for operating a barrier plate is located beside the reflection member.

### BACKGROUND OF THE INVENTION

A conventional head lamp assembly for vehicles known to applicant is shown in U.S. Pat. No. 5,899,559 which includes a reflection member, a lamp, a lens, a fixed board, a barrier plate and an adjusting device. The reflection member includes two focuses and the lamp is located at one of the focuses and the fixed board is located between the lens and the reflection member. The barrier plate is located at a top edge of the fixed board and connected with the adjusting device which includes an electromagnetic valve which is located to the fixed board. When operating the electromagnetic valve, the barrier plate is pivoted to change the high beam and low beam of the head lamp assembly. However, because the electromagnetic valve is directly connected to the fixed board which is made from metal material which absorbs heat from the light beam so that the electromagnetic valve is heated by the absorbed heat of the fixed board so that the magnetic force is reduced because of the high temperature. The weak magnetic force cannot operate the barrier plate successfully so that the current has to be increased and the current increases the temperature of the coil in the valve. A further heat dispensing device is needed to release the heat from the electromagnetic valve and increases the size of the electromagnetic valve.

The present invention intends to provide a head lamp assembly wherein the electromagnetic valve is located beside the fixed board and the reflection member so that the temperature of the electromagnetic valve is controlled within an acceptable range.

### SUMMARY OF THE INVENTION

The present invention relates to a head lamp assembly which comprises a reflection member and a lamp is located at a focus of the reflection member. A fixed board is fixed to the reflection member and has a recess defined in a top edge thereof. An adjusting device includes an electromagnetic valve and a barrier plate which includes a connection arm extending perpendicularly therefrom. The electromagnetic valve is fixed to the fixed board and located beside the reflection member. The electromagnetic valve has a retractable shaft connected to the connection arm and the barrier plate is pivotably connected to the fixed board by a pivot. The barrier plate normally blocks the recess of the fixed board. The barrier plate is pivoted away from the recess when the electromagnetic valve is operated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the head lamp assembly of the present invention;

FIG. 2 is a cross sectional view to show the pivot for connecting the fixed board and the barrier plate;

FIG. 3 is a perspective view to show the first embodiment of the head lamp assembly of the present invention, wherein the barrier plate does not block the recess of the fixed board;

FIG. 4 shows that the barrier plate blocks the recess of the fixed board;

FIG. 5 is an exploded view to show a second embodiment of the head lamp assembly of the present invention;

FIG. 6 is a cross sectional view to show the pivot for connecting the fixed board and the barrier plate of the second embodiment of the head lamp assembly;

FIG. 7 is a perspective view to show the second embodiment of the head lamp assembly of the present invention, wherein the barrier plate does not block the recess of the fixed board, and

FIG. 8 shows that the barrier plate in the second embodiment of the head lamp assembly blocks the recess of the fixed board.

### DETAILED DESCRIPTION OF THE PREFERRED EMBODIMENT

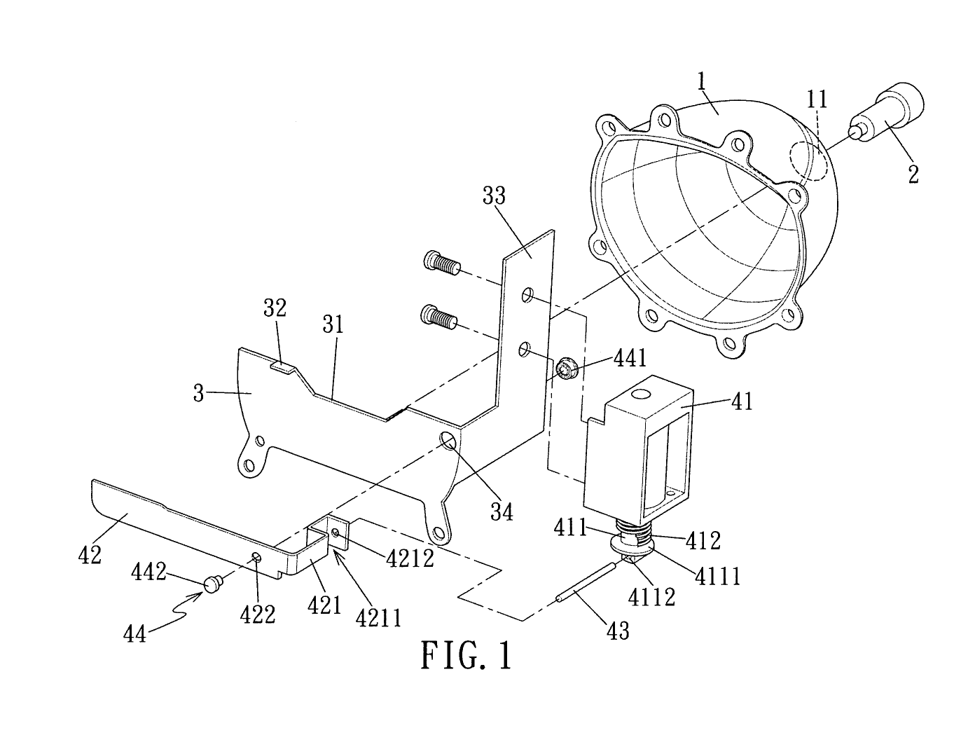

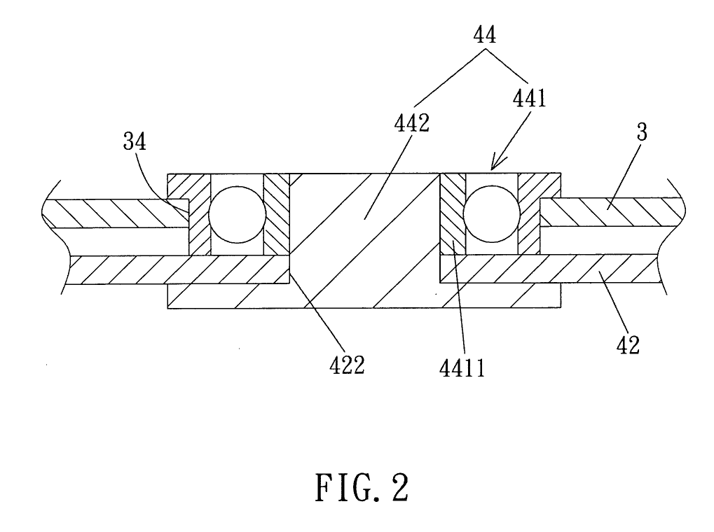

Referring to FIGS. 1 to 3, the first embodiment of the head lamp assembly of the present invention comprises a reflection member 1 which includes an open end and a curved inner surface. A hole 11 is defined in the other end of the reflection member 1 and a lamp 2 is inserted into the reflection member 1 via the hole 11. The lamp 2 is located at a focus of the reflection member 2.

A fixed board 3 is fixed to the open end of the reflection member 1 and has a recess 31 defined in a top edge thereof. The light beam from the lamp 2 is reflected by the curved inner surface of the reflection member 1 and project straight ahead. The high beam is formed when the light beam passes through the recess 31 of the fixed board 3, and the low beam is formed when the recess 31 is blocked by the barrier plate 42 which is described later.

An adjusting device includes an electromagnetic valve 41 and the barrier plate 42, wherein the electromagnetic valve 41 is fixed to a connection portion 33 which extends perpendicularly from one side of the fixed board 3. The electromagnetic valve 41 is located beside the reflection member 1. The electromagnetic valve 41 includes a retractable shaft 411 which extends from an underside of the electromagnetic valve 41 and includes a flange 4111 and a spring 412 is mounted to the retractable shaft 411 and biased between a body of the electromagnetic valve 41 and the flange 4111. The retractable shaft 411 is connected to a connection arm 421 extending perpendicularly from the barrier plate 42. The retractable shaft 411 includes a through hole 4112 defined a side of a distal end thereof and a connection member 43 has a first end extending through the through hole 4112 and a second end of the connection member 43 extends through a third hole 4212 in the connection arm 421 of the barrier plate 42. The third hole 4212 is defined in a bent portion of the connection arm 421 and a recess 4211 is defined by the bent portion, so that the second end of the connection member 43 is located in the recess 4211.

The barrier plate 42 is pivotably connected to the fixed board 3 by a pivot 44 and normally blocking the recess 31 of the fixed board 3. The fixed board 3 includes a first hole 34 and the barrier plate 42 has a second hole 422 which is located in alignment with the first hole 34. The pivot 44 includes a bearing 441 and a pin 442, wherein the bearing 441 is securely engaged with the first hole 34 and the pin 442 extends through the second hole 422 in the barrier plate 42 and is securely engaged with a brace 4411 of the bearing 441. Accordingly, the barrier plate 42 can be smoothly pivoted about the pin 442 by the bearing 441.

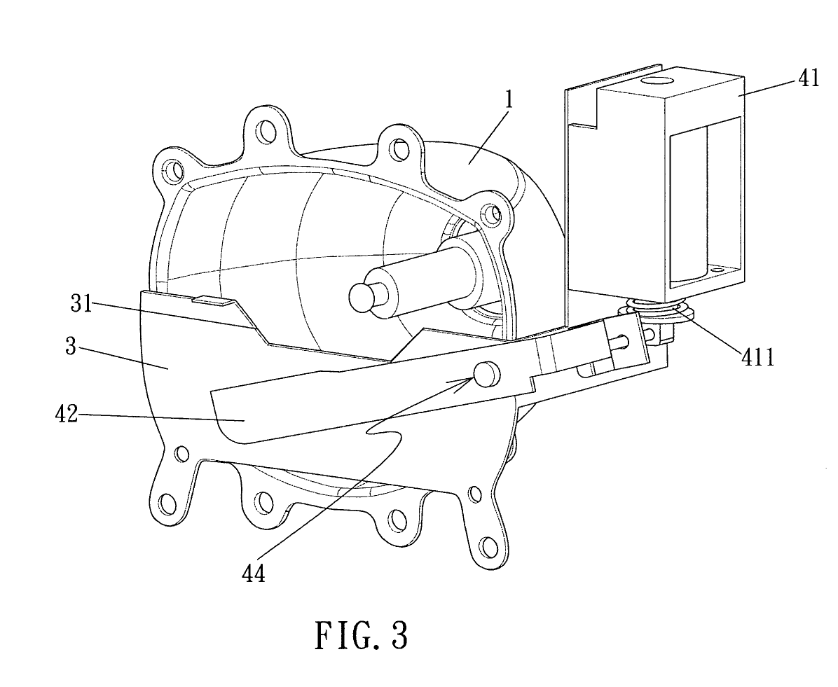

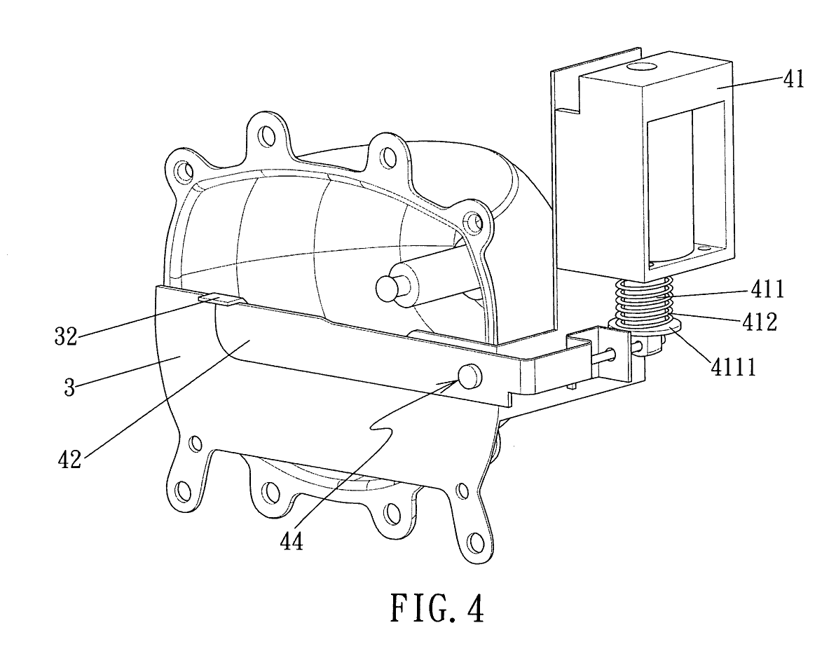

Normally, the barrier plate 42 blocks the recess 31 as shown in FIG. 4 and the head lamp assembly generates the low beam. The fixed board 3 includes a stop 32 which extends from the top edge of the fixed board 3 so as to stop the barrier plate 42. When the driver activates the electromagnetic valve 41, the retractable shaft 411 is retracted so as to pivot the barrier plate 42 away from the recess 31 as shown in FIG. 3, so that the high beam passes through the recess 31. It is noted that the electromagnetic valve 41 is located beside the reflection member 1 so that it is not affected by the heat from the fixed board 3.

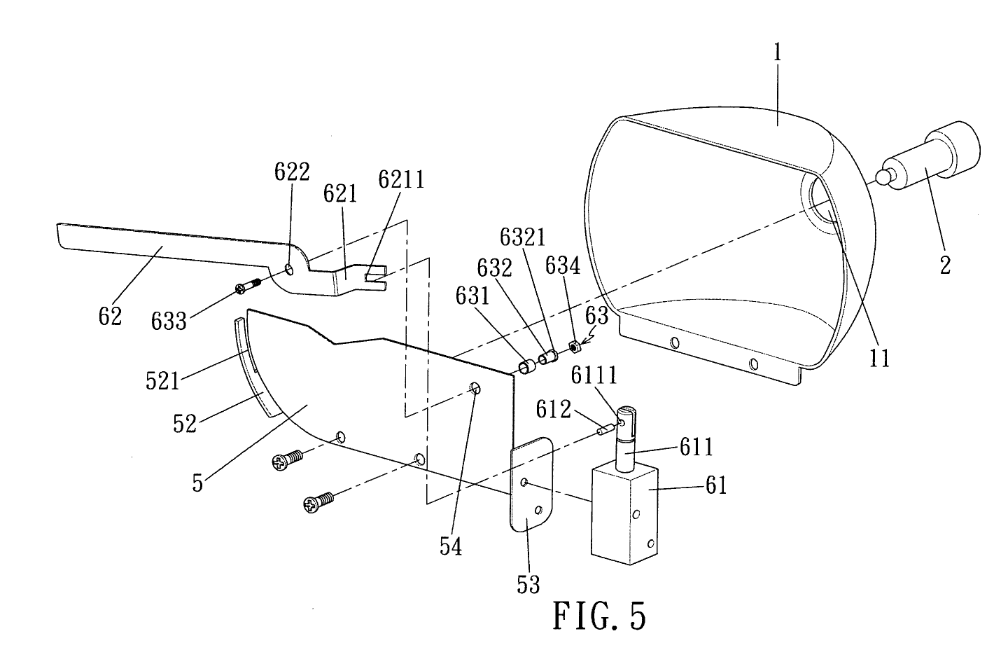

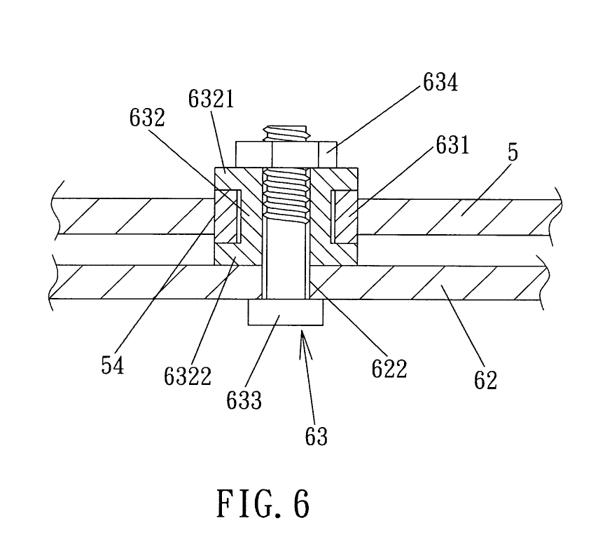

FIGS. 5 to 8 disclose a second embodiment of the head lamp assembly of the present invention, wherein the lamp 2 is located at the focus of the reflection member 1 as the first embodiment, and the fixed board 5 with the recess 51 is connected to the open end of the reflection member 1 as well. The electromagnetic valve 61 is connected to the connection portion 53 extending perpendicular from the fixed board 5 wherein the retractable shaft 611 extends from a top of the electromagnetic valve 61. The barrier plate 62 is pivotably connected to the fixed board 5 by a pivot 63 and an end of the barrier plate 62 is connected to the retractable shaft 611 so as to removably block the recess 51 of the fixed board 5.

A protrusion 52 extends from an end of the fixed board 5 and a slot 521 is defined in the protrusion 52, the barrier plate 62 is received in the slot 521. The retractable shaft 611 of the electromagnetic valve 61 includes a longitudinal slit and the connection arm 621 of the barrier plate 62 includes a fork end 6211 which is inserted in the slit and a fixing pin 612 extends through holes 6111 in two parts separated by the longitudinal slit in the retractable shaft 611 and the fork end 6211.

The pivot 63 includes a first tube 631 securely engaged with a first hole 54 in the fixed board 5 and a second tube 632 extends through the first tube 631. Two flanges 6321, 6322 extend radially from two ends of the second tube 632 and are in contact with two ends of the first tube 631. A bolt 633 extends through a second hole 622 in the barrier plate 62 and the second tube 632 and a nut 634 is connected to the bolt 633. The second tube 632, the bolt and the barrier plate 62 are pivotable relative to the fixed board 5.

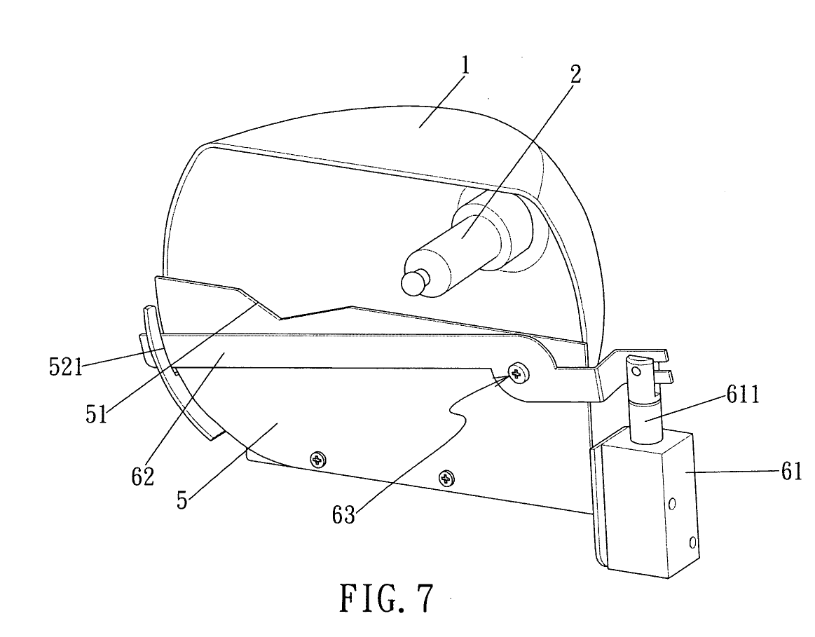

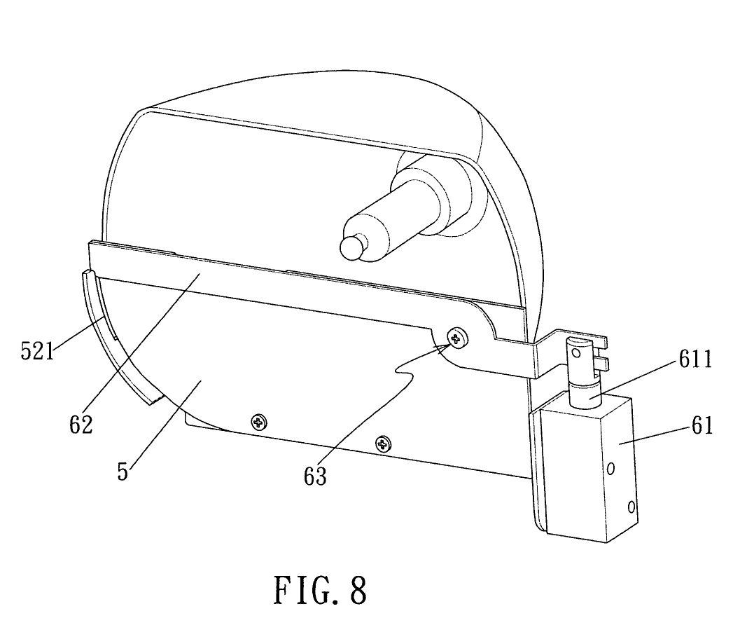

Normally, the barrier plate 62 blocks the recess 51 as shown in FIG. 8 and the head lamp assembly generates the low beam. When the driver activates the electromagnetic valve 61, the retractable shaft 611 extends away from the electromagnetic valve 61 so as to pivot the barrier plate 62 away from the recess 51 as shown in FIG. 7, so that the high beam passes through the recess 51.

While we have shown and described the embodiment in accordance with the present invention, it should be clear to those skilled in the art that further embodiments may be made without departing from the scope of the present invention.

What is claimed is:

1. A head lamp assembly comprising:
a reflection member;
a lamp which is located at a focus of the reflection member;
a fixed board fixed to the reflection member and having a recess defined in a top edge thereof, and
an adjusting device including an electromagnetic valve and a barrier plate, the electromagnetic valve having a retractable shaft which is connected to a connection arm extending perpendicularly from the barrier plate, the barrier plate pivotably connected to the fixed board by a pivot and normally blocking the recess of the fixed board, the barrier plate being pivoted away from the recess when the electromagnetic valve is operated to move the retractable shaft, the electromagnetic valve being fixed to the fixed board and located beside the reflection member.

2. The assembly as claimed in claim 1, wherein the fixed board includes a connection portion which extends perpendicularly from one side of the fixed board, the electromagnetic valve is fixed on the connection portion.

3. The assembly as claimed in claim 1, wherein the fixed board includes a stop which extends from the top edge of the fixed board and stops the barrier plate.

4. The assembly as claimed in claim 1, wherein the pivot includes a bearing and a pin, the fixed board includes a first hole and the barrier plate has a second hole, the bearing is securely engaged with the first hole and the pin extends through the second hole in the barrier plate and is securely engaged with a brace of the bearing.

5. The assembly as claimed in claim 1, wherein the retractable shaft includes a flange and a spring is mounted to the retractable shaft and biased between a body of the electromagnetic valve and the flange.

6. The assembly as claimed in claim 5, wherein the retractable shaft includes a through hole defined a side of a distal end thereof and a connection member extends through the through hole and a third hole in the connection arm of the barrier plate.

7. The assembly as claimed in claim 1, wherein a protrusion extends from an end of the fixed board and a slot is defined in the protrusion, the barrier plate is received in the slot.

8. The assembly as claimed in claim 1, wherein the retractable shaft of the electromagnetic valve includes a longitudinal slit and the connection arm of the barrier plate includes a fork end which is inserted in the slit and a fixing pin extends through holes in two parts separated by the longitudinal slit in the retractable shaft and the fork end.

9. The assembly as claimed in claim 1, wherein the pivot includes a first tube securely engaged with a first hole in the fixed board and a second tube extends through the first tube, two flanges extend radially from two ends of the second tube and are in contact with two ends of the first tube, a bolt extends through a second hole in the barrier plate and the second tube and a nut is connected to the bolt, the second tube, the bolt and the barrier plate are pivotable relative to the fixed board.
